(19) United States
(12) Patent Application Publication
(10) Pub. No.: US 2016/0256991 A1
(43) Pub. Date: Sep. 8, 2016

(54) ROOT SPRING REMOVAL TOOL AND METHOD OF REMOVING A BLADE ROOT SPRING

(71) Applicant: MITSUBISHI HITACHI POWER SYSTEMS AMERICAS, INC., Lake Mary, FL (US)

(72) Inventor: Jonah Compton, Cocoa, FL (US)

(73) Assignee: MITSUBISHI HITACHI POWER SYSTEMS AMERICAS, INC., Lake Mary, FL (US)

(21) Appl. No.: 15/014,719

(22) Filed: Feb. 3, 2016

Related U.S. Application Data
(60) Provisional application No. 62/111,392, filed on Feb. 3, 2015.

(51) Int. Cl. B25B 27/30; F01D 5/30; F01D 5/32

(52) U.S. Cl. CPC B25B 27/308; F01D 5/326; F01D 5/3007; F05D 2230/70; F05D 2240/24

(57) ABSTRACT

An apparatus for removing a root spring, the apparatus including a main body, a punch secured to the main body, and a driving mechanism coupled to the punch, wherein actuation of the driving mechanism moves the linear moving punch forward for engaging the root spring. The main body includes a front plate, a rear plate, a right side plate, a left side plate and an interior portion; wherein the right side plate and left side plate are substantially parallel with each other and each includes an elongated opening and a plurality of notches;

### CROSS-REFERENCE TO RELATED APPLICATION

This application is based upon and claims priority under 35 U.S.C. 119(e) to Provisional Application No. 62/111,392 filed Feb. 3, 2015, the contents of which are incorporated herein by reference in its entirety.

### BACKGROUND

1. Field of Invention

The present invention relates to a root spring removal tool and a method for using the tool to easily and conveniently remove a blade root spring from a blade root portion of a rotor assembly of a turbine.

2. Description of Related Art

As illustrated in FIG. 1, a blade 200 which is a turbine blade includes a blade part 201 and a blade root part 202 provided at one end of the blade part 201 on a rotor disk side. The rotor disk 203 includes a blade groove 204 which has a shape corresponding to the blade root part 202. This blade groove 204 extends along an axial direction of a rotor. The blade 200 is supported by the rotor disk 203 by engaging the blade root part 202 to the blade groove 204. A gap 205 is formed between the blade root part 202 and the blade groove 204. In this gap 205, a blade root spring 206, as illustrated in FIG. 2, is inserted. The blade root spring 206 is configured to press the blade 200 outward in the radial direction of the blade groove 204 so that the blade root part 202 is brought into close contact with the blade groove 204 and the blade 200 is held there, as described in the U.S. patent application Ser. No. 13/847,554.

As shown in FIG. 2, the root spring 206 is a leaf type spring with a narrow profile as viewed in the plane of displacement. This profile extends in the aforementioned plane for a distance approximately 20 the width profile. This geometry provides a large contact surface on both sides of the blade root spring 206, which allows the blade root spring 206 to push the blade 200 outward in the radial direction with respect to the rotor disk 203. However, this large contact surface creates a significant amount of friction when trying to remove the blade root spring 206.

Prior art techniques for removing a worn root spring include using a hammer to strike a narrow brass rod or similar material as a punch that is aligned by an operator with the root spring. However, it is difficult for the operator to align the punch so it is collinear with the axis of the root spring. Typically, the operator places the punch at an awkward angle to the root spring, which reduces the effectiveness of the punch, since the punch has the tendency to lose contact with the spring root when the punch is struck with the hammer. This causes the operator to spend additional time and effort to remove the root spring and increases the risk of the operator damaging the turbine disk or turbine blades during the removal process.

### BRIEF SUMMARY OF THE INVENTION

In view of these circumstances, an aspect of the present invention is to provide a spring root removal tool that provides a collinear force to the root spring and mitigates the occurrence of the spring removal tool from losing contact with the root spring during removal. According to another aspect of the invention, the spring root removal tool is hand operated and designed to remove the root spring in a restricted space, i.e., between two adjacent rows of turbine blades. The spring root removal tool may be used in all types of turbine engines, including gas turbine engines, steam turbine engines, aircraft engines, and others.

According to another aspect of the present invention for removing a root spring, the apparatus comprising: a main body; a punch secured to said main body; and a driving mechanism coupled to said punch, wherein actuation of said driving mechanism moves said linear moving punch forward for engaging the root spring.

According to another aspect of the present invention, an apparatus, comprising: a main body including a front plate, a rear plate, a right side plate, a left side plate and an interior portion; wherein the right side plate and left side plate are substantially parallel with each other and each includes an elongated opening and a plurality of notches; a linkage mechanism attached to the main body and configured to slide along the elongated openings; a punch provided in the interior portion and configured to be attached to the linkage mechanism; a driving mechanism coupled to the linkage mechanism and configured to engage the plurality of notches, the driving mechanism drives the punch via the linkage mechanism by engaging at least one the plurality of notches in a ratchet like manner. According to another aspect of the present invention, the front plate, the rear plate, the right side plate and the left side plate are joined together at substantial right angles. According to another aspect of the present invention, the elongated openings extend across substantially the entire right and left side plates. According to another aspect of the present invention, the plurality of notches extend across substantially the entire right and left side plates. According to another aspect of the present invention, the elongated openings have substantially the same size and shape. According to another aspect of the present invention, the plurality of notches have substantially the same size and shape. According to another aspect of the present invention, the front plate included\s a through hole for receiving the punch. According to another aspect of the present invention, a handle configured to be attached to the driving mechanism. According to another aspect of the present invention, the front plate includes a recess portion. According to another aspect of the present invention, the rear plate includes a recess portion. According to another aspect of the present invention, the punch includes an opening, an end portion and a tip portion. According to another aspect of the present invention, the linkage mechanism includes a small through hole and a large through hole.

### BRIEF DESCRIPTION OF THE DRAWINGS

Further characteristics and advantages of the present invention will be more readily apparent from the description of the preferred by non-exclusive embodiments of the root spring removal tool and method, illustrated by way of non-limiting examples in the accompanying drawings, in which:

FIG. 1 shows a conventional a turbine blade that includes a blade part and a blade root part.

FIG. 2 shows a conventional leaf type root spring with a narrow profile as viewed in the plane of displacement.

FIGS. 3A and 3B show a root spring removal tool according to an embodiment of the present invention.

FIG. 4 shows a perspective view of right and left side plates according an embodiment of the present invention.

FIGS. 5A and 5B show a perspective view of a front plate according an embodiment of the present invention.

FIGS. 6A and 6B show a perspective view of a rear plate according an embodiment of the present invention.

FIG. 7 shows a perspective view of a linear moving punch according an embodiment of the present invention.

FIG. 8 shows a perspective view of a sliding bolt according an embodiment of the present invention.

FIG. 9 shows a perspective view of a linkage mechanism according an embodiment of the present invention.

FIG. 10 shows a perspective view of a driving mechanism according an embodiment of the present invention.

FIG. 11 shows a perspective view of a securing bolt according an embodiment of the present invention.

FIG. 12 shows a perspective view of a handle according an embodiment of the present invention.

FIGS. 13-19 illustrate an example according to an aspect of the present invention of how an operator is able to remove a root spring using a root spring tool.

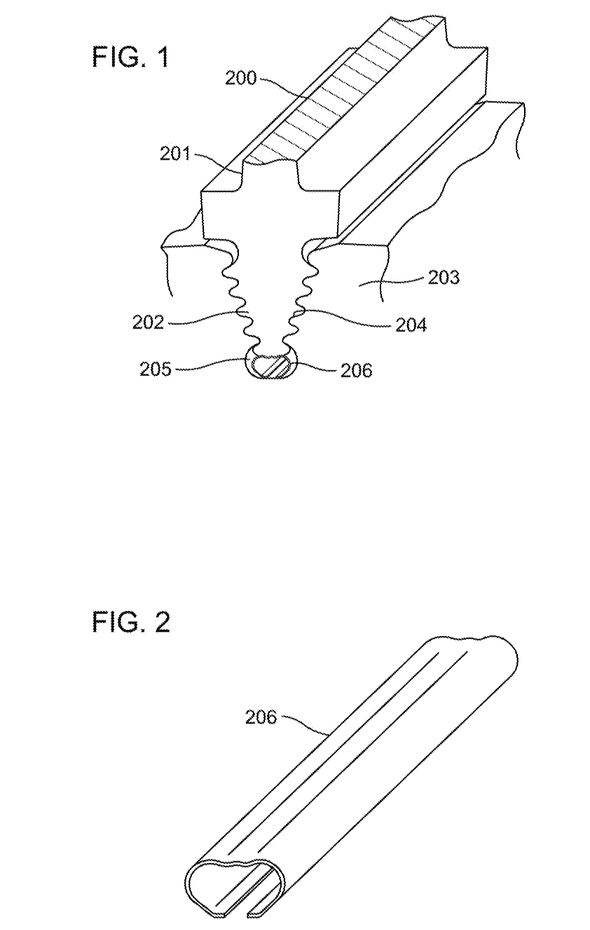

The same reference numerals have used to identify similar elements in the Figures.

### DESCRIPTION OF THE INVENTION

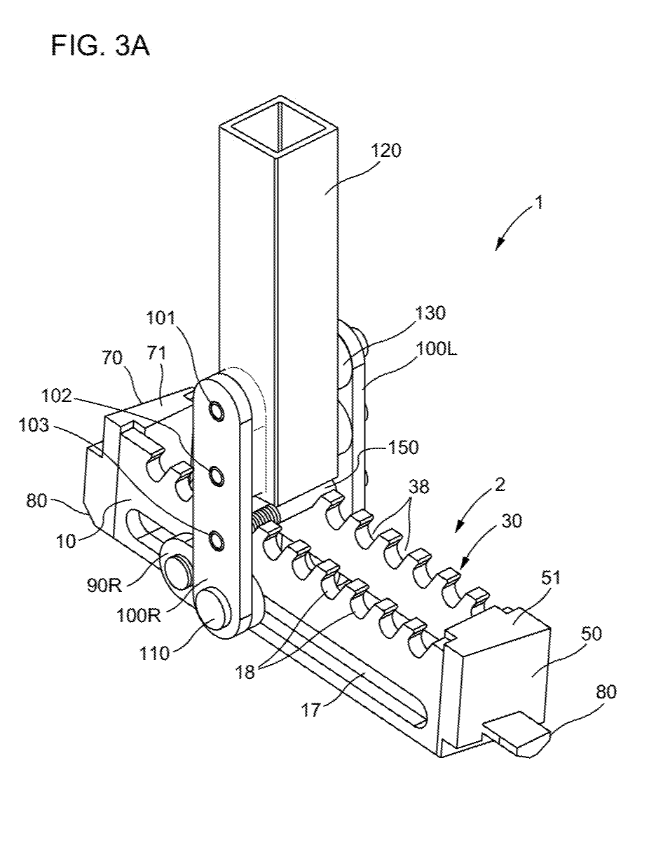

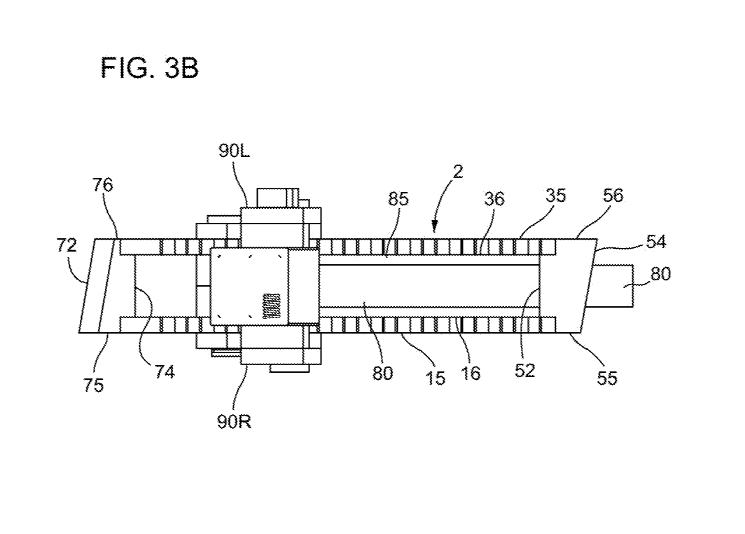

FIGS. 3A and 3B illustrates an embodiment of a root spring removal tool according to an aspect of the present invention. As shown in FIGS. 3A and 3B, a root spring removal tool 1 includes a main body 2, which is comprised of four plates, a right side plate 10, a left side plate 30, a front plate 50, and a rear plate 70. The front plate 50, rear plate 70 and the right and left side plates 10 and 30 are attached (or welded) together at substantial right angles to form the main body 2.

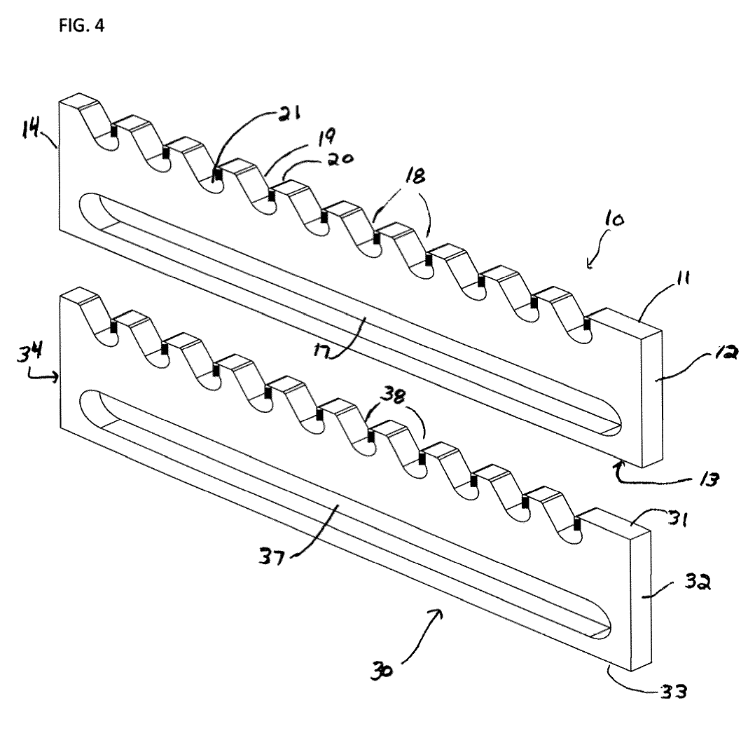

As shown in FIGS. 3B and 4, the right side plate 10 has a top surface 11, a rear surface 12, a bottom surface 13, a front surface 14, an outer surface 15, an inner surface 16, an elongated opening 17 and a plurality of notches 18. The elongated opening 17 is provided entirely within the lower half of the right side plate 10 and extends across substantially the entire right side plate 10 in an axial direction of the main body 2. The plurality of notches 18 are provided in the upper half of the right side plate 10 in a ratchet like pattern. Each of the notches 18 may be of the same size and may be provided an equal distance a part from each other. As shown in FIG. 3A and 4, each of the notches 18 has a right side wall 19, a left side wall 20 and a bottom portion 21. The right and left side walls 18 and 19 extend in parallel to each other and are inclined towards the front plate 50 such that the side walls 18 and 19 form an acute angle with the top surface 11.

As illustrated in FIG. 3B and 4, the left side plate 30 has the same configuration as the right side plate 10 and is provided in parallel with the right side plate 10 in the main body 2. That is, the left side plate 30 includes a top surface 31, a rear surface 32, a bottom surface 33, a front surface 34, an outer surface 35, an inner surface 36, an elongated opening 37 and a plurality of notches 38. In addition, the elongated opening 37 of the left side plate 30 has substantially the same size and shape as the elongated opening 17 of the right side plate 10 and the elongated openings 17 and 37 are provided in parallel with each other in the main body 2. Similarly, the notches 38 of the left side plate 30 each have substantially the same size and shape as the notches 18 of the right side plate 10 and are provided in parallel with each other in the main body 2.

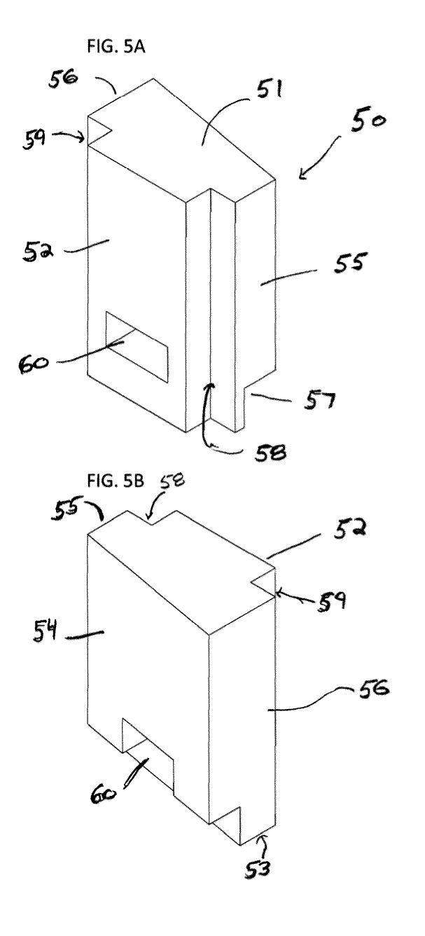

As illustrated in FIGS. 5A and 5B, the front plate 50 has a top surface 51, a rear (inner) surface 52, a bottom surface 53, a front surface 54, a right side surface 55 and a left side surface 56. As also illustrated in FIGS. 5A and 5B, the front plate 50 includes a front recessed portion 57, which is formed along the bottom of the front plate 50; and the inner surface 52 includes right and left recessed portions 58 and 59, which are formed along the right and left edges of the inner surface 52, respectively. The front recessed portion 57 is configured such that the front plate 50 of the main body 2 can be positioned on the appropriate hardware of the rotor disk during removal of a root spring. The right and left recessed portions 58 and 59 are provided for welding the front plate 50 to the front surfaces 14, 34 of the right and left side plates 10 and 30, respectively.

In addition, as shown in FIGS. 5A and 5B, the front plate 50 includes a through hole 60, for example, having a rectangular shape that extends from the rear inner surface 52 to the front surface 54. The through hole 60 is provided just above the front recessed portion 57 and at a substantially equal distance away from the right and left side surfaces 55 and 56. As illustrated in FIGS. 3B and 5A, the front surface 54 is offset at an acute angle from the inner surface 52, such that the left side surface 56 has a longer length than the right side surface 55, in order for the front surface 54 to have the same angle as the blade grooves in the rotor disc, as discussed more fully below.

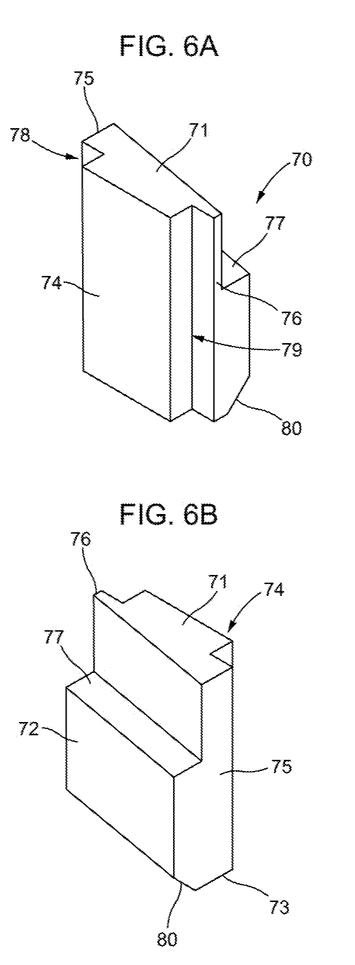

As illustrated in FIGS. 6A and 6B, the rear plate 70 includes a top surface 71, a rear surface 72, a bottom surface 73, a front (inner) surface 74, a right side surface 75 and a left side surface 76. As also illustrated in FIGS. 6A and 6B, the rear plate 70 includes a rear recess portion 77 and an incline surface 80, which are both formed on the rear surface 72. The rear recess portion 77 is formed on the top half of the rear surface 72 and the incline surface 80 is formed at the corner of the rear surface 72 and the bottom surface 73. Both the rear recess portion 77 and the incline surface 80 are configured such that the rear plate 70 of the main body 2 can be positioned on the appropriate hardware of the rotor disk during removal of a root spring.

Further, as illustrated in FIG. 6A and 6B, the inner surface 74 includes right and left recessed portions 78 and 79, which are formed along the right and left edges of the inner surface 74, respectively. The right and left recessed portions 78 and 79 are provided for welding the rear plate 70 to the rear surfaces 12, 32 of the right and left side plates 10 and 30, respectively.

As illustrated in FIGS. 3B and 6B, the rear surface 72 is offset at an acute angle from the inner surface 74, such that the right side surface 75 has a longer length than the left side surface 76. That is, as shown in FIG. 3B, the rear surface 72 is substantially in parallel with the front surface 54 of the front plate 50 in the main body 2 in order for the offset front surface 54 and rear surface 72 to have the same angle as the blade grooves in the rotor disc, as discussed more fully below. In addition, as shown in FIG. 3B, the inner surface 52 of the front plate 50 and the inner surface 74 of the rear plate 70 are substantially in parallel with each other in the main body 2.

As discussed above, the front plate 50, the rear plate 70 and the right and left side plates 10 and 30 are welded together at substantial right angles to form the main body 2. More specifically, the right and left recessed portions 78 and 79 of the rear plate 70 are welded to the rear surfaces 12, 32 of the right and left side plates 10 and 30, respectively; such that the top surface 71, the bottom surface 73 and the right and left side surfaces 75 and 76 of the rear plate 70 are substantially flush with the top surfaces 11, 31, the bottom surfaces 13, 33 and the outer surfaces 15, 35, of the left and right side plate 10 and 20, respectively. And, the right and left recessed portions 58 and 59 of the front plate 50 are welded to the front surfaces 14, 34 of the right and left side plates 10 and 30, respectively; such that the top surface 51, the bottom surface 53 and the right and left side surfaces 55 and 56 of the front plate 50 are substantially flush with top surfaces 11, 31, the bottom surfaces 13, 33 and the outer surfaces 15, 35, of the right and left side plates 10 and 30 respectively.

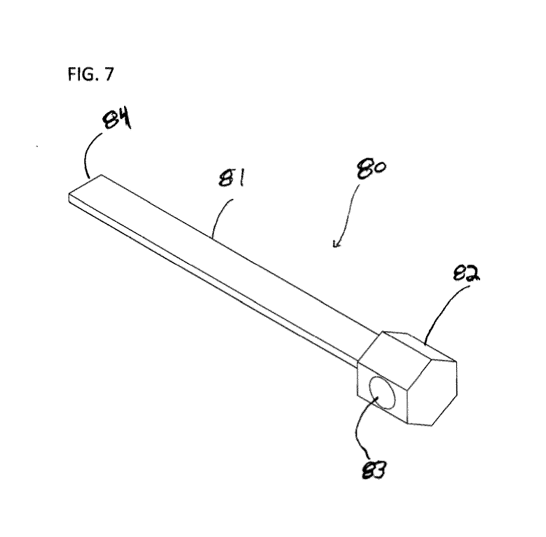

As illustrated in FIG. 3B, the main body 2 has an interior portion 85, which is formed by welding the front and rear plates 50 and 70 to the right and left side plates 10 and 30. A linear moving punch 80 is provided to move within the interior portion 85. As shown in FIG. 7, the linear moving punch 80 has a ram portion 81 and an end portion 82. The ram portion 81 has a tip portion 84 and the end portion 82 has an opening 83, which is provided on two opposite sides of the end portion 82 and passes completely through the center of the end portion 82. The opening 83 is configured to receive a sliding bolt 140, which is used to secure the linear moving punch 80 to the main body 2 via the elongated openings 17 and 37.

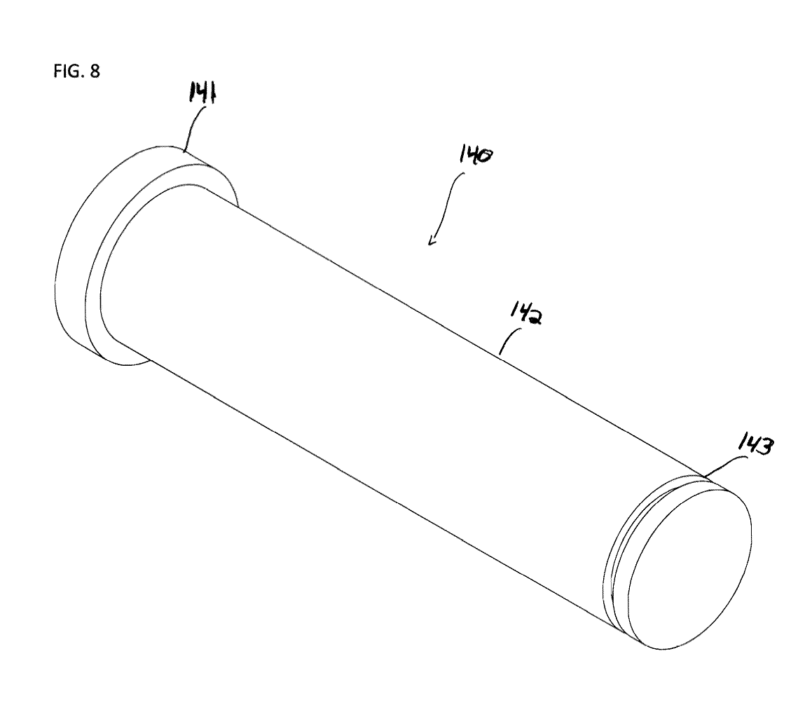

As illustrated in FIG. 8, the sliding bolt 140 includes a bolt head portion 141, a main portion 142 and a groove portion 143, which is able to receive a retainer spring (not shown). The bolt head 141 has a larger diameter than the main portion 142 and is provided at an opposite end from the groove portion 143. The main portion 142 has a cylindrical shape with a diameter slightly less than the width of the elongated holes 17, 37, which allows the main portion 142 to move freely along the elongated holes 17, 37.

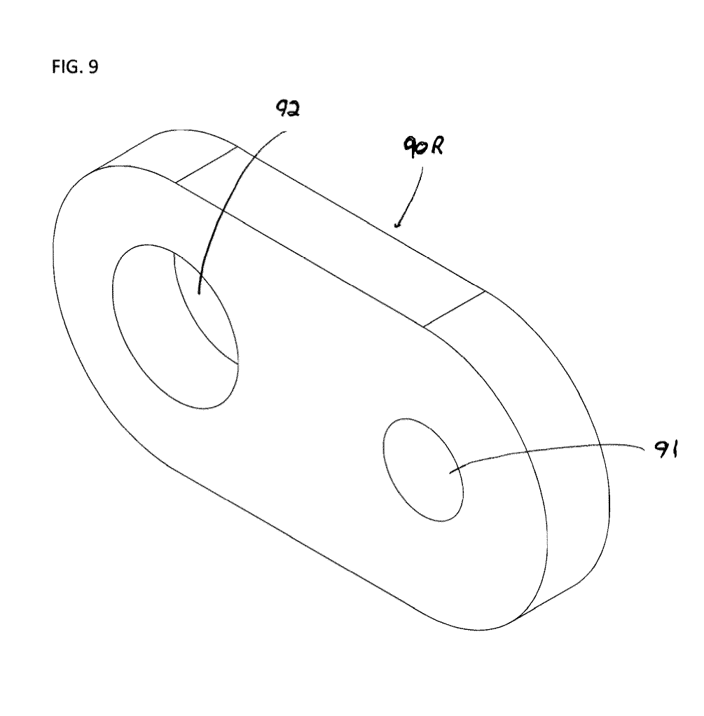

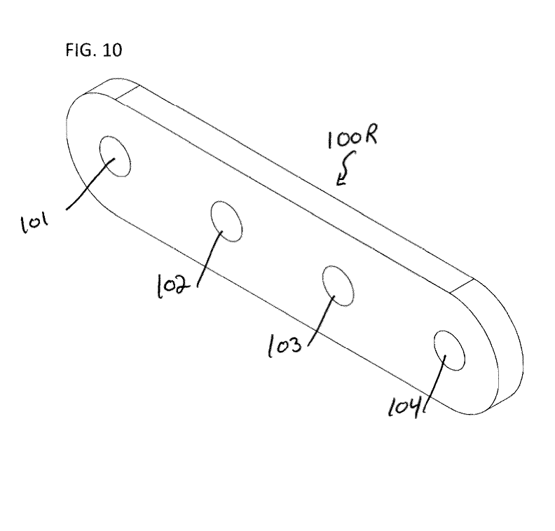

Right and left linking mechanisms 90R, 90L are provided, as shown in FIGS. 3B and 9, in order secure the linear moving punch 80 to the elongated holes 17 and 37 of the main body 2. As illustrated in FIG. 9, the right linking mechanism 90R has an oval type shape and includes a small (diameter) through hole 91 and a large (diameter) through hole 92. The left linking mechanism 90L has the same configuration as the right linking mechanism 90R.

In order to secure the moving punch 80 to the main body 2, the large through holes 92 of the linking mechanisms 90R, 90L are aligned with the elongated holes 17, 37, respectively, and the sliding bolt 140 is provided through the left linking mechanism 90L, the elongated hole 37, the opening 83 of the moving punch 80, the elongated hole 17 and the right linking mechanism 90R and is then secured by placing a retainer spring ring (not shown) in the groove portion 143.

Once the moving punch 80 is secured to the main body 2, the ram portion 81, which extends from the center of the end portion 82 in the axial direction and has the same shape as the through hole 60, is able to pass through the through hole 60 of the front plate 50 and remove a root spring as the linear moving punch 80 is advanced forward along the elongated openings 17 and 37, as discussed more fully below.

The linking mechanisms 90R, 90L are also configured to be secured to driving mechanism 100R, 100L, respectively, by using securing bolt 110, as shown in FIG. 3A. As illustrated in FIG. 10, the right driving mechanism 100R has an elongated oval shape and includes first, second, third and fourth through holes 101-104 all of which have substantially the same diameter as each other as well as that of the small through holes 91 of the linking mechanisms 90R, 90L. The left driving mechanism 100L has the same configuration as the right driving mechanism 100R.

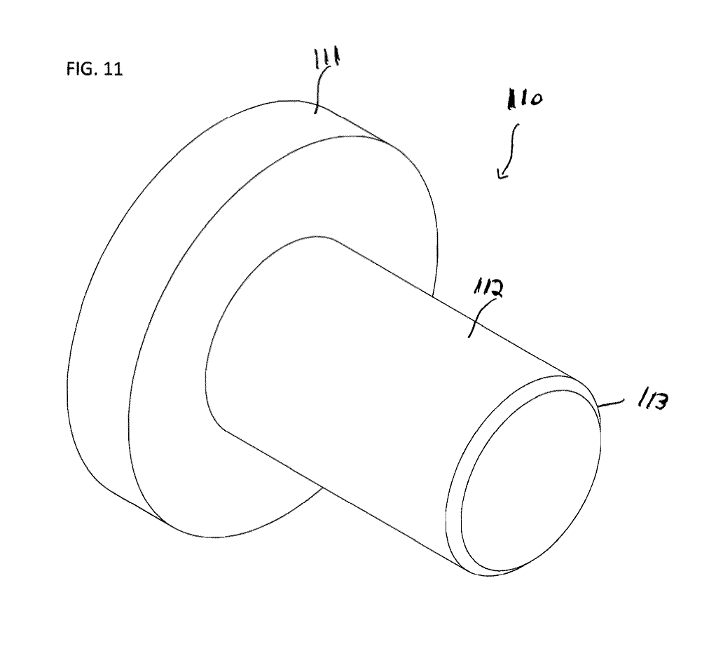

As shown in FIG. 11, the securing bolt 110 has a bolt head portion 111, a cylinder portion 112 and a flange portion 113. The head portion 111 has a diameter larger than the cylinder portion 112 and the cylinder portion 112 has a diameter just slightly smaller than the fourth through hole 104 of the driving mechanisms 100R, 100L and the small through hole 91 of the linking mechanisms 90R, 90L. As shown in FIG. 3A, the securing bolt 110 is inserted through the small through hole 91 of the linking mechanism 90R and into the fourth through hole 104 of the driving mechanism 100R, such that the linking mechanism 90R is attached to the driving mechanism 100R. The same procedure is provided for attaching the linking mechanism 90L to the driving mechanism 100L.

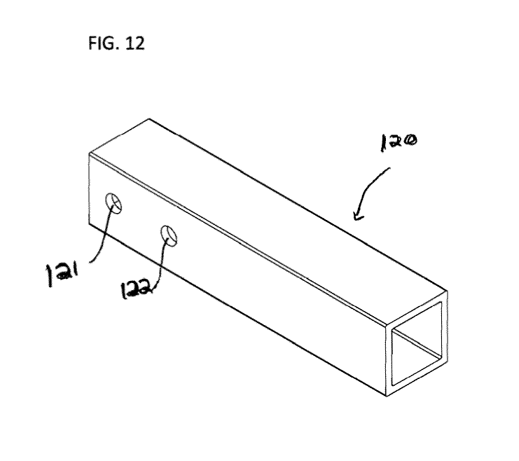

As shown in FIG. 3A, the driving mechanisms 100R, 100L extend in a radial direction and are attached to each other via their respective first, second and third and through holes 101-103. As shown in the FIG. 3A, a lever handle 120 is secured between the driving mechanisms 100R, 100L at the first and second through holes 121 and 122. That is, as shown in FIG. 12, the handle 120 has a rectangular cuboid shape and includes first and second holes 121, 122 provided on two opposite sides of the handle 120. The first and second holes 121 and 122 are provided the same distance apart as the first and second through holes 101 and 102 such that the first and second holes 121 and 122 can be aligned with the first and second through holes 101 and 102 and the driving mechanisms 100R, 100L can be attached to each other with the handle 120 in between via two screws. In addition, washers 130, as shown in FIG. 3A, are provided between the handle 120 and each of the driving mechanism 100R, 100L in order to for the handle 120 to be securely position between the driving mechanisms 100R, 100L. Also, the first and second through holes 101 and 102 of the right driving mechanism 100R each have internal threads for receiving the screws used to attach the handle 120 to the driving mechanisms 100R, 100L.

In addition, as shown in FIG. 3A, a ratchet screw 150 is provided between the third through holes 103 of the driving mechanism 100R, 100L. The ratchet screw 150 is configured to screw into the internal threads of the right driving mechanism 100R and is provided at a height such it is able to engage with the plurality of notches 18 and 38 of the main body 2 in a ratchet like manner, as discussed more fully below.

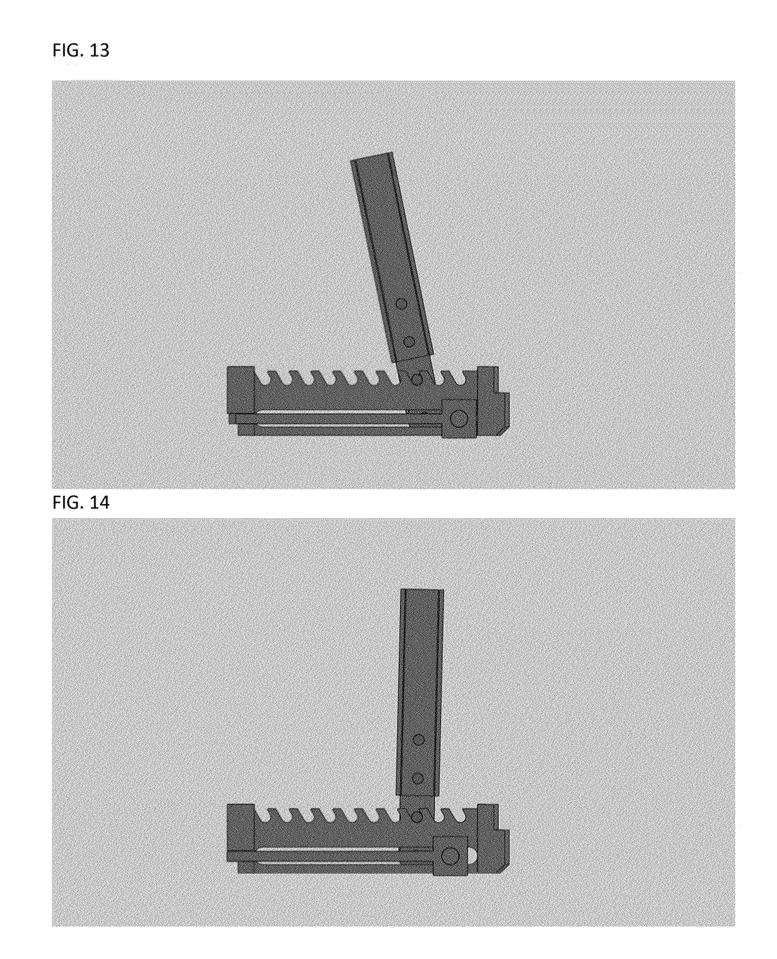

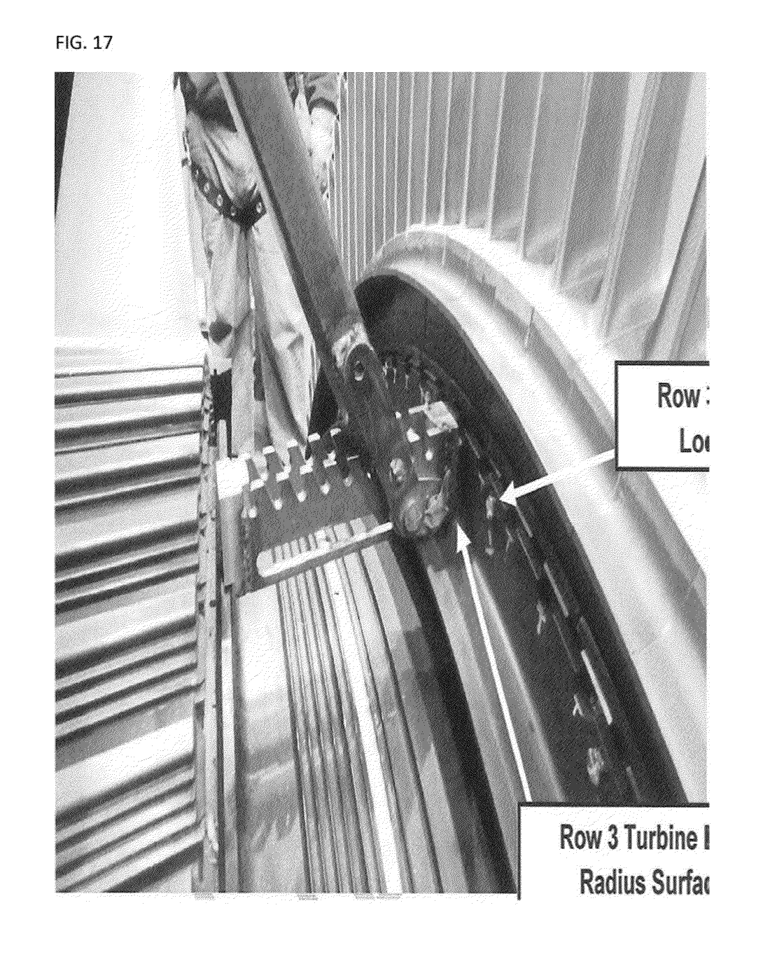

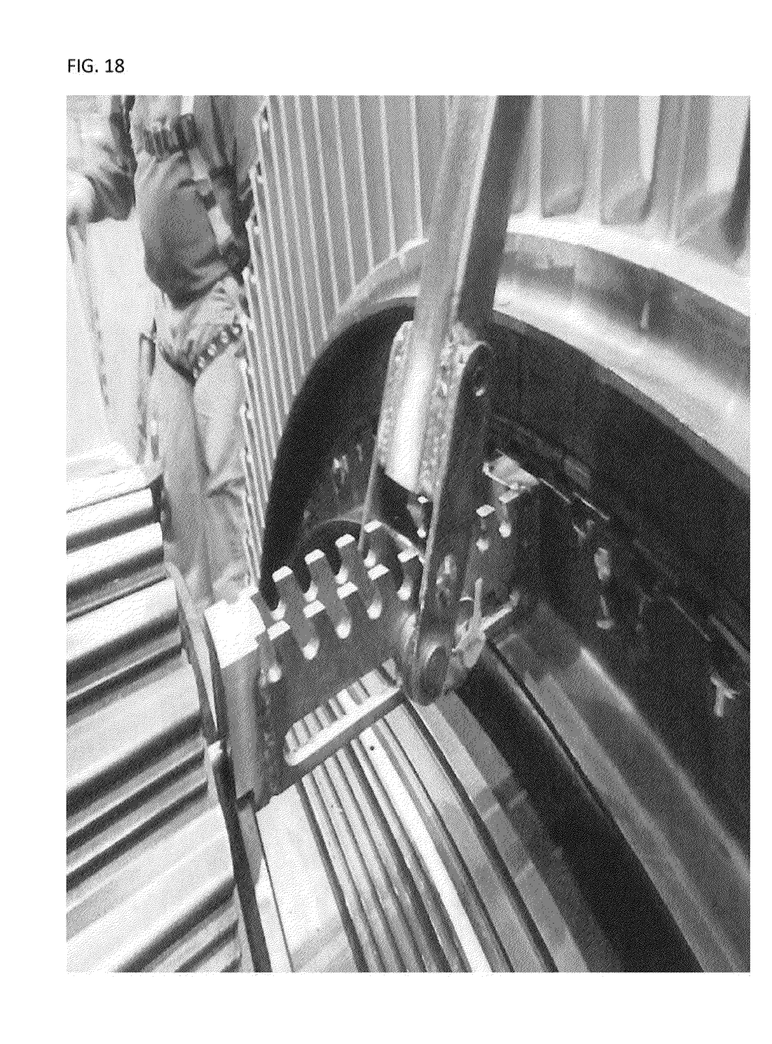

FIGS. 13-19 illustrate an example according to an aspect of the invention of how an operator is able to remove a root spring using the root spring tool 1. First, as shown in FIG. 17, the main body 2 is provided between two adjacent rows of turbine blades. For example, if the fourth row of turbine blade has a root spring, then the main body will be positioned between the third 160 and fourth 170 rows. Specially, the incline surface 80 and the rear recess portion 77 of the rear plate 70 are configured such that the rear plate 70 can be positioned on the radius surface of the turbine disc of the third row 160 without interfering with the disc's radius circumferential surface and its downstream locking screws, respectively. And, the front plate 50 of the main body 2 can be positioned on the appropriate hardware of the rotor disk of the fourth row 170 based on the configuration of the front recessed portion 57, as shown in FIG. 17.

Next, after the main body 2 is properly installed between the third 160 and fourth 170 rows of turbine blades, the tip portion 84 of the moving punch 80 is then align with the root spring that is to be removed. That is, the main body 2 is configured such that once it is install between the rows, the moving punch 80 is provided at substantially the same height as the root spring that is to be removed. Further, since the front surface 54 and the rear surface 72 are offset to have the same angle as the blade groove in the rotor disc, as discussed above, the moving punch 80 is provided to be collinear with the axis of the root spring.

In an initial position, as shown in FIG. 13, the end portion 82 of the moving punch 80 is provided near the rear plate 30 and the tip portion 84 does not extend beyond the front surface 54 of the front plate 50. In this initial position, an operator places the ratchet screw 150 in a pair of parallel notches 18 and 38 located slightly downstream of the linkage mechanisms 90R, 90L and positions the driving mechanisms 100R, 110L and the lever handle 120 slightly forward at an angle this is equal to or less than the right and left side walls 19 and 20 the notches 18.

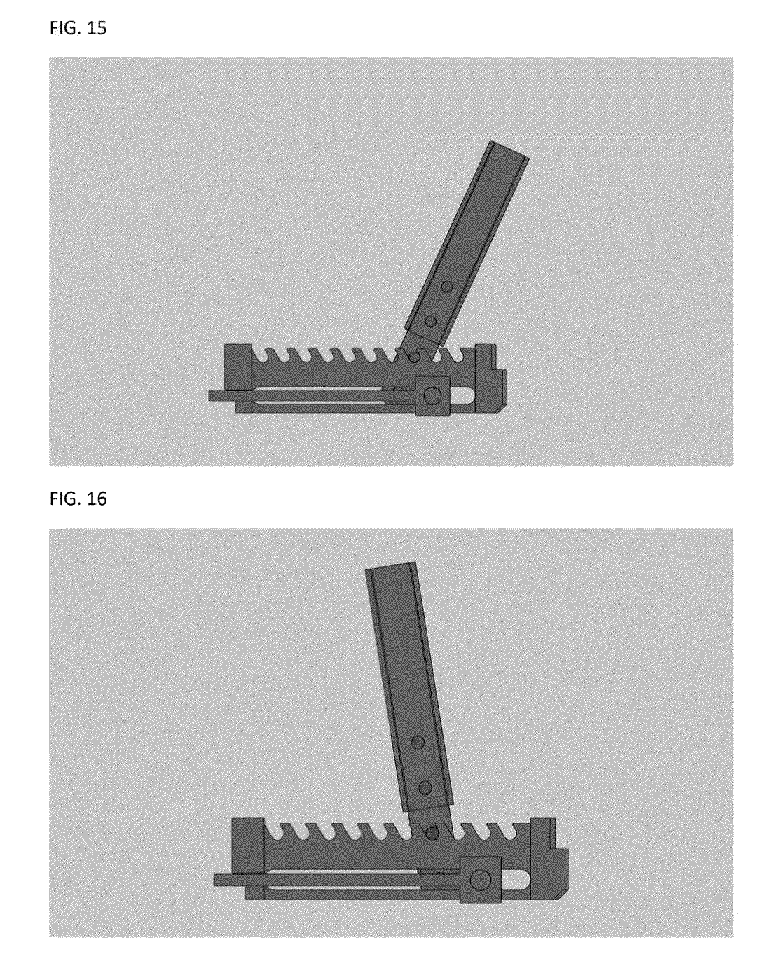

Next, the operator pulls the lever handle 120 towards the rear plate 70 into an intermediate position, as shown in FIG. 14, such that the driving mechanisms 100R, 110L and handle 120 rotate about the axes of the notches 18 and 38, which drives the linear moving punch 80 forward along the elongated grooves 17, 37, and finally into a pulled position, as shown in FIGS. 15 and 18. This movement causes the end portion 82 to advance downstream in the grooves 17, 37, as shown in FIGS. 14 and 15, which allows the tip portion 84 of the punch 80 to advance through the passage 60 and to extend beyond the front surface 54 of front plate 50, as shown in FIG. 15.

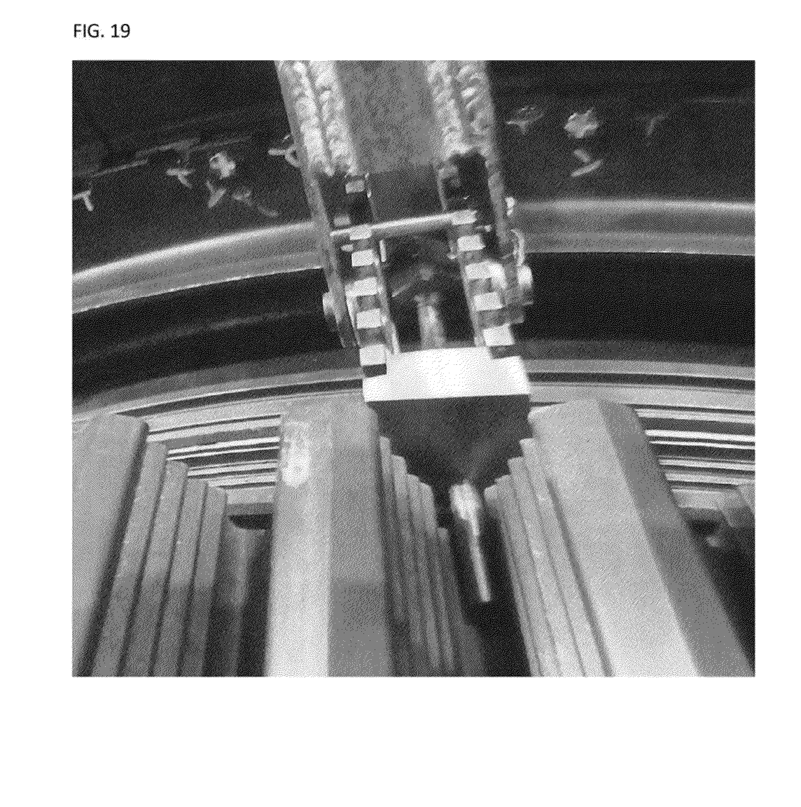

After the operator finishes with the pull action, the operator then advances the ratchet screw 150 into the next downstream pair of notches 18, 38 and begins again at the initial position as shown in FIG. 16. As this sequence is repeated for each of the subsequent pairs of downstream notches 18, 38, the moving punch 80 advances into the blade root portion as shown in FIG. 19 and the blade root is pushed out of the blade root accordingly. That is, the multiple axes of the notches 18, 38 are laid out in a ratchet-like manner and the spacing of these multiple axes are designed to allow successive actuations of the handle 120 in the restricted operating area between two rows of turbine blades.

From the above description of preferred embodiments of the invention, those skilled in the art will perceive improvements, changes and modifications. Such improvements, changes and modifications within the skill of the art are intended to be covered by the appended claims. Further, it should be apparent that the foregoing relates only to the described embodiments of the present application and that numerous changes and modifications may be made herein without departing from the spirit and scope of the application as defined by the following claims and the equivalents thereof.

### REFERENCE LIST

Root spring removal tool 1, Main body 2.

Right side plate 10, top surface 11, rear surface 12, bottom surface 13, front surface 14, outer surface 15, inner surface 16, elongated opening 17, notches 18, right and left side walls 19 and 20, bottom portion 21.

Left side plate 30, top surface 31, rear surface 32, bottom surface 33, front surface 34, outer surface 35, inner surface 36, elongated opening 37, notches 38.

Front plate 50, top surface 51, rear surface 52, bottom surface 53, front surface 54, right side surface 55, left side surface 56, front recessed portion 57, right recessed portion 58, left recessed portion 59, front through hole 60.

Rear plate 70, top surface 71, rear surface 72, bottom surface 73, front (inner) surface 74, right side surface 75, left side surface 76, rear recess portion 77 and incline surface 80, right and left recessed 78, 79, interior portion 85.

Linear moving punch 80, ram portion 81, end portion 82, opening 83, tip portion 84 (FIG. 7).

Sliding bolt 140, bold head portion 141, main portion 142, and groove portion 143 (FIG. 8).

Linkage mechanism 90R, 90L, small through hole 91, large through hole 92 (FIG. 9).

Driving mechanism 100R, 100L, first through hole 101, second through hole 102, third through hole 103 and fourth through hole 104 (FIG. 10).

Securing bolt 110, bold head portion 111, cylinder portion 112 and flange portion 113 (FIG. 11).

Lever handle 120, first and second through hole 121, 122 (FIG. 12)

Washer 130, Ratchet screw 150, Third row of turbine blades 160, Fourth row of turbine blades 170

I claim:

1. An apparatus for removing a root spring, the apparatus comprising:
a main body;
a punch secured to said main body; and
a driving mechanism coupled to said punch,
wherein actuation of said driving mechanism moves said linear moving punch forward for engaging the root spring.

2. An apparatus, comprising:
a main body including a front plate, a rear plate, a right side plate, a left side plate and an interior portion; wherein the right side plate and left side plate are substantially parallel with each other and each includes an elongated opening and a plurality of notches;
a linkage mechanism attached to the main body and configured to slide along the elongated openings;
a punch provided in the interior portion and configured to be attached to the linkage mechanism;
a driving mechanism coupled to the linkage mechanism and configured to engage the plurality of notches,
wherein the driving mechanism drives the punch via the linkage mechanism by engaging at least one the plurality of notches in a ratchet like manner.

3. The apparatus of claim 2, wherein the front plate, the rear plate, the right side plate and the left side plate are joined together at substantial right angles.

4. The apparatus of claim 2, wherein the elongated openings extend across substantially the entire right and left side plates.

5. The apparatus of claim 2, wherein the plurality of notches extend across substantially the entire right and left side plates.

6. The apparatus of claim 4, wherein the elongated openings have substantially the same size and shape.

7. The apparatus of claim 2, wherein the plurality of notches have substantially the same size and shape.

8. The apparatus of claim 2, wherein the front plate includes a through hole for receiving the punch.

9. The apparatus of claim 2, further comprising: a handle configured to be attached to the driving mechanism.

10. The apparatus of claim 2, wherein the front plate includes a recess portion.

11. The apparatus of claim 2, wherein the rear plate includes a recess portion.

12. The apparatus of claim 2, wherein the punch includes an opening, an end portion and a tip portion.

13. The apparatus of claim 2, wherein the linkage mechanism includes a small through hole and a large through hole.
